(19) United States
(12) Patent Application Publication
(10) Pub. No.: US 2008/0059212 A1
(43) Pub. Date: Mar. 6, 2008

(54) System and method for assembling complex document sets from geographically disparate sources

(76) Inventors: Andrei Obrea, Seymour, CT (US); Frederick W. Ryan, Oxford, CT (US); Robert A. Cordery, Danbury, CT (US); Easwaran Nambudiri, Rye Brook, NY (US); Benjamin D. Singer, Chicago, IL (US); John W. Sussmeier, Cold Spring, NY (US)

Correspondence Address: PITNEY BOWES INC.;35 WATERVIEW DRIVE, P.O. BOX 3000, MSC 26-22, SHELTON, CT, 06484-8000, US

(21) Appl. No.: 11/513,755

(22) Filed: Aug. 31, 2006

(51) Int. Cl. G06Q 10/00; G06Q 30/00

(52) U.S. Cl. 705/1

(57) ABSTRACT

A method includes assigning a respective document tracking identifier to each of a plurality of documents. The documents are required for a college admission application. The user is allowed to register, with a central computer, as an applicant for college admissions in connection with the college admission application. The document tracking identifiers are associated with the user. It is detected whether or not the documents are handled by a document delivery service. A report is made to the user, via the central computer, as to at least some data obtained from the detecting step.

### BACKGROUND

This invention relates to systems for tracking documents.

The process of applying for college admissions can be stressful for applicants. Even administrative aspects of the process may present significant challenges. According to a typical sequence of events, an applicant receives or downloads an admission application packet from a college or university in which the applicant is interested. For the application to be complete, several documents are required to be submitted to the college admissions office. These may include an essay and an application form to be completed by the applicant, a high school grade transcript to be submitted directly to the college admissions office by the high school guidance department, and letters of recommendation to be prepared by teachers and/or other persons acquainted with the applicant. The letters of recommendation are also typically submitted directly to the college admissions office from the individuals who prepare the letters.

In most cases, the documents required for completion of the admission application are submitted on time to the admissions office. But there are problems that may arise. For example, the high school guidance department may be tardy in sending the applicant's transcript to the admissions office and/or the applicant's references may be slow to prepare their letters of recommendation. It is also possible for these documents to be mailed to the wrong address. Generally, the applicant's only way to determine that nothing has gone wrong with his/her application is to query the admissions office as to the status of the application, and to follow up with individuals who were responsible for submitting documents that the admissions office reports have not yet been received. Among other disadvantages of this arrangement is the fact that there is a delay between the time when a document is sent to the admissions office and the time when the document is received. As a result, the applicant may be informed that the application is incomplete at a time when all needed documents already are in the mail. This, in turn, may cause the applicant to remind references or the guidance department to take actions that those parties have already completed.

### SUMMARY

According to an aspect of the invention, a method includes assigning a respective document tracking identifier to each of a plurality of documents (e.g., the documents that are required for a college admission application). The method further includes allowing a user to register, with a registration authority such as a central computer, the document tracking identifiers for use in a document assembly process (e.g., college application submissions for an applicant for college admissions in connection with the college admission application). The method may also include associating the document tracking identifiers with the user, detecting handling or absence of handling of the documents by a document delivery service, and reporting to the user, via the central computer, at least some data obtained from the detecting step.

The method may also include detecting whether one of the documents has failed to be handled by the document delivery service by a pre-determined time, and notifying the user that the document has failed to be handled by the document delivery service.

The document delivery service may be the U.S. Postal Service. The document tracking identifiers may be evidenced as PLANET codes on the documents. As used herein and in the appended claims, the term “document” includes a piece of paper with information printed thereon and/or an envelope which contains or is appointed to contain such a piece of paper.

The detecting step may include scanning PLANET codes on envelopes carried by the U.S. Postal Service.

The method may further include sending an electronic mail reminder from the central computer to a third party whom the user requested to submit one of the documents.

The assigning step may include associating, in the central computer, the document tracking identifiers with the college admission application of the user. In addition, or alternatively, the assigning step may include a college admissions office applying the document tracking identifiers on envelopes and sending the envelopes to the user. In addition, or alternatively, the assigning step may include the user downloading the document tracking identifiers from the central computer, the user printing out the document tracking identifiers on labels, and the user applying the labels to the documents.

The reporting step may include reporting to the user when each of the plurality of documents is delivered to a college admissions office.

In another aspect, a method includes associating a plurality of documents with a completion task, and tracking whether and to what extent each of the documents progresses through a document delivery system to a destination.

The completion task may be completion of a college admission application and the destination may be a college admissions office. The document delivery service, as before, may be the U.S. Postal Service, and the tracking step may include receiving information from the U.S. Postal Service. The tracking step may include reading PLANET codes on the documents.

In other embodiments, the completion task may be completion of an insurance claim file or completion of a record of a hospital admission.

In still another aspect, a computer system includes a database that includes a plurality of applicant records. Each record is for associating a plurality of document tracking identifiers with a respective applicant. The computer system also includes a receiving mechanism for receiving data from a document delivery service. The data is indicative of locations at which the document tracking identifiers are detected by the document delivery service. The computer system also includes a mechanism, responsive to the receiving mechanism, for accessing the database and reporting, to the applicants, progress of documents through the document delivery service.

The computer system may further include a mechanism for reporting, to the applicants, impending deadlines relevant to document tracking identifiers that have not been detected.

The computer system may further include a mechanism for sending electronic mail reminders to parties appointed to send documents. This mechanism may send the reminders in response to the receiving mechanism not receiving reports of respective document tracking identifiers.

The computer system may further include a mechanism for receiving data from applicants to associate the applicants with respective sets of the document tracking identifiers.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a schematic functional block diagram of a system provided in accordance with the invention for assembling and tracking components of college admission applications.

FIG. 2 is a block diagram of an admissions applications tracking server that is part of the system of FIG. 1.

FIGS. 3A and 3B together form a flow chart that illustrates a process that may be performed in the system of FIG. 1.

FIG. 4 illustrates an example set of document labels that may be employed in the system of FIG. 1.

FIG. 5 is a flow chart that illustrates a process that may be performed by the admissions applications tracking server of FIG. 2.

FIG. 6 is a flow chart that illustrates another process that may be performed by the admissions applications tracking server.

### DETAILED DESCRIPTION

The present invention, in certain of its aspects, gives an applicant for college admission detailed and up-to-date knowledge of the status of the various documents which are required for his/her application. This is done by assigning a group of U.S. Postal Service (“U.S.P.S.”) PLANET codes to the documents and using the U.S.P.S. CONFIRM service to track whether or not and at what locations the PLANET codes for the application are detected during handling of the applications documents by the U.S.P.S. This may give the applicant close to real-time information as to whether or not the various component documents of the application have been mailed. Consequently, the applicant also has close to real-time information as to component documents which have not yet been mailed, so that the applicant may follow up and provide reminders to the parties responsible for completing/dispatching the component documents. A central computer is in communication with, or at least receives information from, U.S.P.S. computers that track PLANET code data. The central computer also operates to receive registrations from applicants and to associate specific groups of PLANET code numbers with specific applications and the corresponding applicants. In addition, the central computer may track application deadlines and may issue automatic notices/reminders, to applicants and/or parties responsible for mailing documents, when a deadline is approaching and the corresponding PLANET codes for the required documents have not yet been detected.

The principles of the present invention are also applicable to other types of sets of documents that are collected from various parties and that may be tracked through a system for delivering the documents. Document tracking systems other than the U.S.P.S. CONFIRM system may be employed, and so may document tracking identifiers other than PLANET codes. The actual technique used to detect identifiers on documents is not limited to barcode scanning.

It should be understood that the term “document delivery service”, as used herein and in the appended claims, refers to the U.S.P.S. or any other postal authority, foreign or domestic, or any entity such as Fedex or UPS which delivers documents from a sender to a recipient. Moreover, the documents which are the subject of this invention may be in electronic rather than paper form and may be delivered by data and/or facsimile transmission rather than by physical transportation. Thus the term “document delivery service” may also include an electronic mail system, or a telecommunications system, or the like.

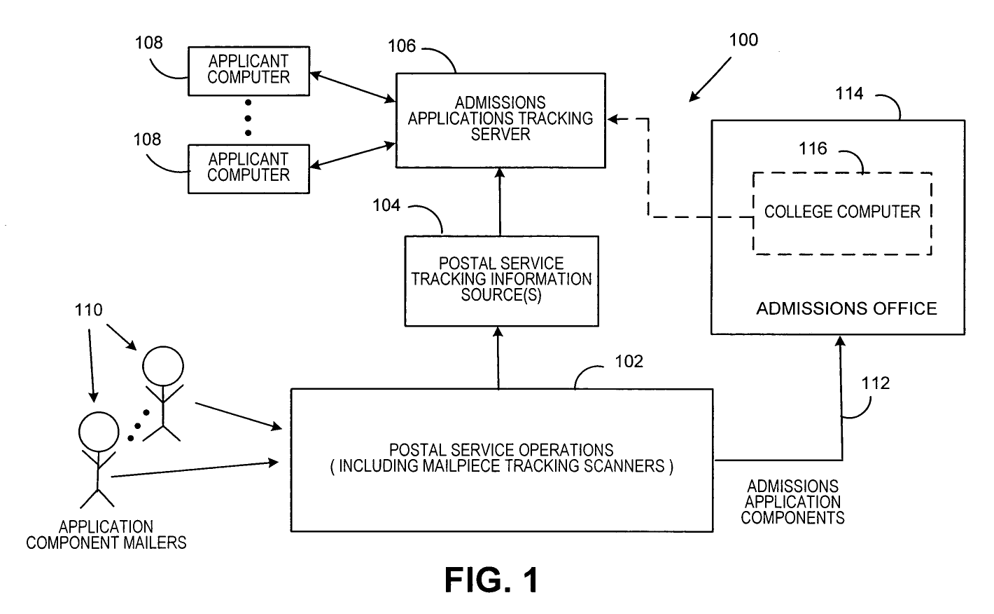

FIG. 1 is a schematic functional block diagram of a system 100 provided in accordance with the invention for assembling and tracking components of college admission applications.

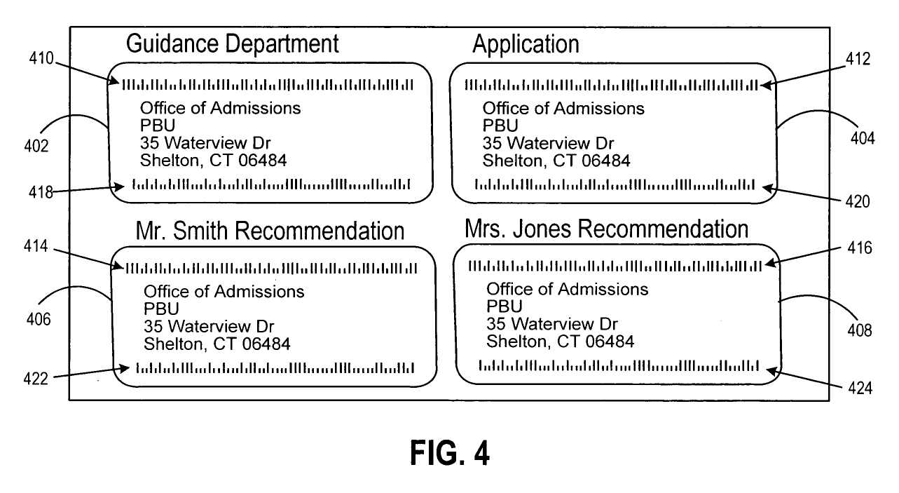

The application tracking system 100 may effectively include postal automation equipment and other aspects of U.S.P.S operations (collectively indicated at 102), including equipment (not separately shown) which scans and reads barcodes such as POSTNET barcodes (representing destination zip codes) and/or PLANET codes which are present on mail pieces transported and delivered by the U.S.P.S. As is well known to those involved with the mailing industry and allied industries, a PLANET code is a bar/halfbar code specified by the U.S.P.S., printed at the top of the recipient address field on a mail piece, and used to track the mail piece through its handling by the U.S.P.S. Block 104 in FIG. 4 represents U.S.P.S. data processing capabilities which receive and distribute information concerning sightings of specific PLANET codes and/or POSTNET codes by the U.S.P.S. operations 102. With regard to the incoming document process, multiple tracking codes may be placed on the envelope or label for use in situations in which International applicants send mail through multiple postal authorities.

At the heart of the application tracking system 100 is a central server computer 106 which provides over-all college admissions application tracking functions and allied functions. The server computer 106 may be in communication with the U.S.P.S. data processing equipment 104 to receive document tracking information from the U.S.P.S. data processing equipment 104. (The server computer 106 may, but need not, be operated by an entity separate from and/or independent of the U.S.P.S. However, in other embodiments, the server computer 106 may be effectively included in and/or integrated with the U.S.P.S. data processing equipment 104.)

Personal computers, laptop computers and the like, operated by applicants and/or prospective applicants for college admission, are indicated at 108 and may be used from time to time to exchange data communications with the server computer 106. (Although not so indicated explicitly in the drawing, data connections between the server computer 106 and the applicant computers may be made via a data network such as the Internet.) The applicant computers may include the usual array of peripheral devices, including, for example, one or more printers, which are not separately shown.

Indicated schematically at 110 are individuals such as applicants, high school guidance personnel and writers of letters of recommendation, all of whom may deliver documents to the postal service operations 102 for delivery (112) by the U.S.P.S. to a college admissions office 114. In some embodiments, the college admissions office may use scanners to read PLANET codes (or other document tracking techniques) to track application components within the admissions office itself. In such a case, the internal document tracking information may be collected and stored in a computer 116 (shown in phantom) maintained by the admissions office 114. The college computer 116 may forward document tracking information to the central server computer 106.

Although only one college admissions office is depicted in FIG. 1, nevertheless in a practical embodiment of the application tracking system 100, many different colleges and universities may participate. A central computer is one of several possible implementations of a registration authority. In an alternative, the system may use a distributed network and/or a peer-to-peer network. In a setup registration process, the schools or other entities that use the system register with the central computer to establish the accounts and data associations required for use of the system. Similarly, in an alternative, multiple distinct delivery services and/or distinct postal authorities may be used for incoming delivery and the appropriate tracking systems utilized.

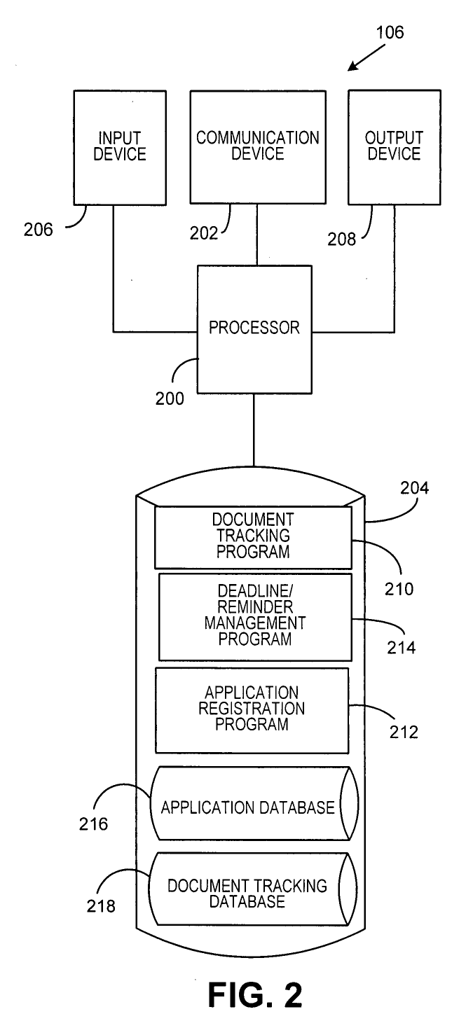

FIG. 2 is a block diagram of a typical embodiment of the server computer 106. In its hardware aspects, the server computer 106 may be entirely conventional. For example, the server computer 106 may include one or more conventional microprocessors, as indicated at 200. The processor 200 may be coupled to one or more communication device(s) 202, such as communication ports which allow the processor to communicate with other devices such as applicant computers 108 (FIG. 1). In addition, the server computer may include one or more storage device(s), indicated at 204 and in communication with the processor 200. The storage device(s) 204 may include one or more hard disk drives, optical media drives, solid state memory, etc.

The server computer 106 may also include one or more input device(s) 206 that are in communication with the processor 200 and may include, e.g., a keyboard and a mouse (not separately shown). In addition, the server computer 106 may include one or more output device(s) 208 that are in communication with the processor 200 and may include, e.g., one or more printers and/or display screens.

Software programs to control operation of the processor 200 and hence the server computer 106 may be stored, temporarily and/or permanently, in one or more of the storage device(s) 204. Such programs may include a program 210 to control the server computer 106 to track documents that are components of college admission applications. One or more other programs 212 may control the server computer 106 to allow college admission applicants to register therewith. Still another program 214 may allow the server computer 106 to keep track of deadlines that are relevant to the applicants' admission applications, and to send out reports, reminders, etc., to applicants or other parties concerned with mailing documents that are components of the admission applications. These programs may cause the server computer 106 to implement at least some of the functionality described below. Although separately represented in the drawings, any two or more of these programs may be effectively combined and/or integrated with each other.

Other software components may be present, although not explicitly represented in the drawing. For example, the storage device(s) 204 may also store conventional software programs such as one or more operating systems, device drivers, web-hosting software and one or more database management systems.

In addition, the storage device(s) 204 may store a database 216 of college admission applicants who have registered with the server computer 106. The information stored in the database 216 may include the names of the admission applicants, identification numbers for the applicants, their mailing addresses, their electronic mail addresses (possibly including text or instant messaging addresses as well), the names of the colleges to which each one is applying for admission, application completion deadlines for each application, the names of the high schools that the applicants attend, the electronic mail addresses of the pertinent high school guidance departments, the names and electronic mail addresses of the individuals asked to write letters of recommendation for the applicants, and a group of document tracking numbers (identifiers) for each college admission application of each registered applicant. Each document tracking number may be associated in the database 216 with a respective component document for the college admission application in question. The system may match the unique ID with the particular workflow elements and for example, a reference letter may be defined as a specific type.

Still further, the storage device(s) 204 may store a database 218 to hold data relating to the tracking of the application component documents through the U.S.P.S. operations 102 (FIG. 1). For example, the database 218 may store, for each document tracking number in the database 216, an indication as to whether that document tracking number has yet been reported from U.S.P.S. computers 104 as having been detected in the U.S.P.S. operations 102. The database 218 may also store times and locations, if any, at which the document tracking numbers have been detected in the U.S.P.S. operations 102. Additionally, a process may be applied to provide for deactivating the system with regard to a particular applicant such as by the student or school when an application is withdrawn or otherwise terminated. Additionally, the system may store estimated delivery times based upon tracking data associated with prior deliveries.

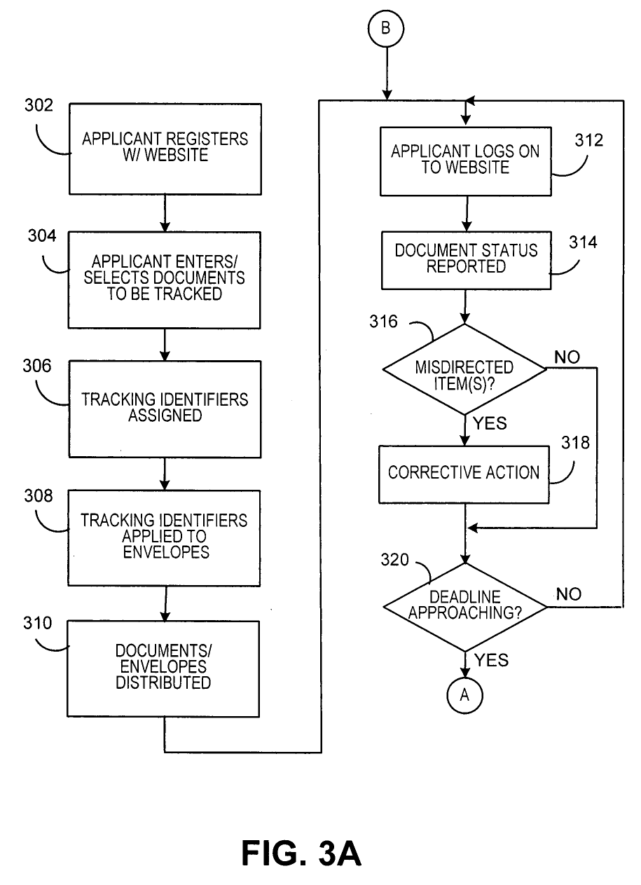

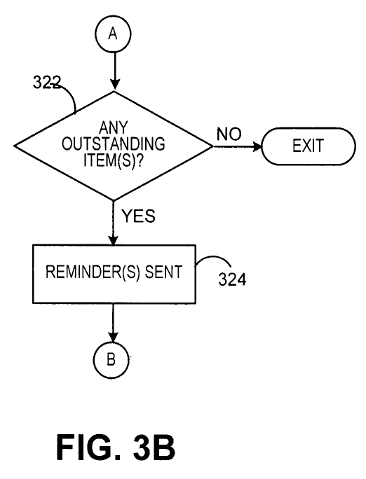

FIGS. 3A and 3B together form a flow chart that illustrates a process that may be performed in the application tracking system 100.

At 302 in FIG. 3A, an applicant for college admissions may register as a user at a website hosted by the server computer 106. This step may include the applicant creating an account/log-in ID, etc. The applicant may enter his/her name, address, e-mail address, telephone number and other information. The other information may include an indication of the high school which the applicant attends. This indication may be provided, for example, from a pull-down menu of the high schools in the state in which the applicant resides. With this indication provided, the server computer 106 may be able to populate parts of the applicant's record related to his/her high school, including the e-mail address of the guidance department for that school. Alternatively, a third party agent such as a guidance counselor or guidance department affiliated person may register on behalf of the applicant.

At 304, the applicant may identify admissions application component documents to be tracked by the system 100. As a first stage of this task, the applicant may enter/select the colleges/universities he/she is applying to. This again may be done from pull-down menus. Once a college is selected, the applicant may be presented with a list of documents required by that college. The list may be entered by the college at some time such as during the registration process with the registration authority and/or generated based upon data input by prior applicants. The applicant may also enter information to indicate the names of each person who is to write a letter of recommendation for each admissions application. The e-mail addresses or other contact information of the letter-writers may also be included in the information input to the server computer 106 by the applicant or retrieved from a database (e.g., the high school database). Furthermore, if the email addresses are retrieved from a database, they may be hidden from the applicant.

At 306, the server computer 106 may assign document tracking numbers to the admission application component documents to be submitted by the applicant himself/herself, by the high school guidance department, and by the letter-writers (and by any other persons required to submit documents). The server computer may then download, to the applicant's computer, image data that represents labels to be printed by the applicant and attached (308) to envelopes in which the component documents are to be sent to the college admissions offices. FIG. 4 shows examples of such labels, including a label 402 for sending the transcript from the high school guidance department, a label 404 for use by the applicant in sending his/her essay and the application form itself, and labels 406, 408 for the respective use of two individuals who are to submit letters of recommendation. The respective PLANET codes on the labels are shown at 410, 412, 414, 416. The POSTNET codes 418, 420, 422 and 424 are all the same on each of the labels, and reflect the extended zip code specific to the college admissions office to which the application is to be sent.

In an alternative embodiment, each college admissions office may obtain blocks of document tracking numbers and place them on envelopes (e.g., in the form of PLANET codes) to be distributed to applicants as part of admission application packages. In a further alternative, the document tracking numbers may be printed directly on the documents and used with windowed envelopes that allow the numbers to be read. The admissions office may also provide PIN numbers or the like to the applicants, to be used by the applicants in accessing the server computer 106 website to link the applicants to the document tracking numbers they have received. At the same time, the applicants may identify and provide e-mail addresses for their references, to tie the references to specific document tracking numbers. By having the college place the tracking codes on return envelopes, the applicant would be relieved from printing labels himself/herself. The college could also use the codes for internal tracking once the application has been received. In a school workflow, different individuals may process certain document types in the application. When the server computer 106 links an applicant's name and/or letter-writers' names to document tracking identifiers, this also may be considered assigning document tracking identifiers to specific admission application component documents.

Referring once more to FIG. 3A, at 310, the applicant delivers, to the school guidance office and to the letter-writers, the envelopes bearing the address of the college admissions office and the tracking numbers that are unique to each envelope. In the case of the letter-writers, the applicant may also provide them with forms for the letters of recommendation.

Thereafter, as indicated at 312, the applicant may from time to time use his/her computer 108 to access the website hosted by the document tracking server 106. When the applicant does so, he/she may download (step 314) from the server 106 a report on the status of each of the component documents of each of his/her admissions applications. In addition or alternatively, the server 106 may send e-mail reports or text messages of that information to the applicant's computer 108 without requiring a request for a report from the applicant. The reports may be sent periodically or be triggered by specific events such as the mailing of a document, a specified time before a particular deadline or upon by receipt of a particular type of document by the college.

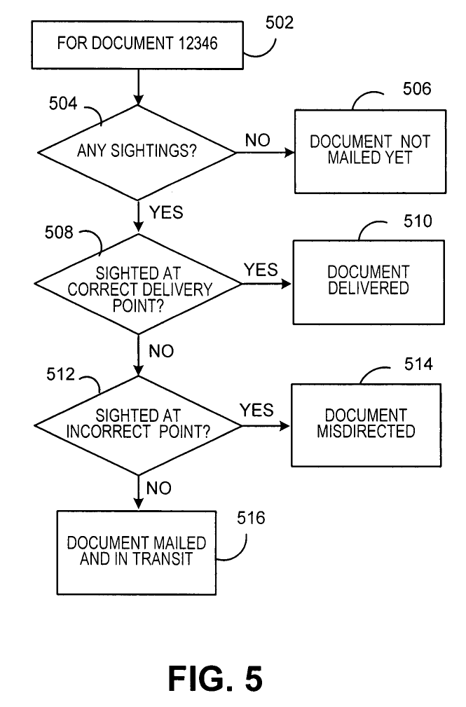

FIG. 5 is a flow chart that illustrates a process that the server 106 may apply at frequent intervals with respect to each document tracking number that is currently active. For a typical one of the document tracking numbers, as indicated at 502, the server 106 determines at 504 whether the server 106 has received any reports of sighting of the document tracking number from the U.S.P.S. If not, then the status of the corresponding document is “not yet mailed”, as indicated at 506. On the other hand, if the document tracking number in question has been detected at least once by the U.S.P.S. scanning equipment (as reported to the server 106), then the server 106 determines at 508 whether the last sighting for the document tracking number was at the correct delivery point for the college admissions office to which the document was intended to be delivered. If so, the server 106 ascribes the status “delivered” to the document, as indicated by 510. In addition, or alternatively, the status “delivered” may be assigned to a document (or confirmed) upon the college admissions office itself scanning the identifying code on the envelope and reporting the sighting to the server 106 via the college computer 116.

Referring again to the determination at 508, if the final correct sighting has not yet been reported, then the server 106 determines at 512 whether the document tracking number has been detected at some U.S.P.S. location which is not on the route to the intended recipient admissions office. If so, then the server 106 assigns the status “misdirected” to the document in question, as indicated at 514. Misdirection of the document may occur, for example, if the POSTNET barcode or another portion of the recipient address suffers defacement.

If a negative determination is made at 512, then (step 516) the server 106 assigns the status “mailed and in transit” to the document in question. The server may also calculate an estimated delivery date for the document based upon past U.S.P.S. performance.

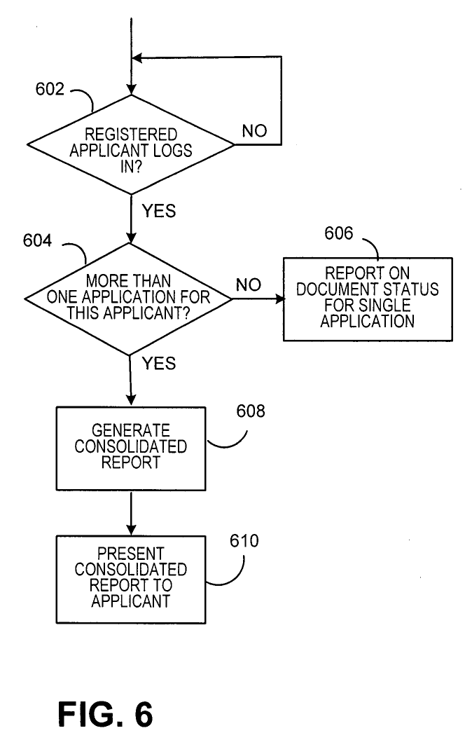

When an applicant logs on to the tracking server website to learn the status of his/her admission application component documents, it may be desirable, in accordance with some embodiments, that the applicant receive a consolidated report with respect to all of his/her admission applications. A process performed by the server 106 to make that possible is illustrated in the flow chart shown in FIG. 6.

At 602 in FIG. 6, it is determined at the server 106 whether a registered applicant has logged on to the website. If so, then at 604, it is determined whether (at least as far as the server knows) the applicant is making applications to more than one college. If a negative determination is made at 604, then 606 follows, at which the server 106 reports to the applicant the current status of the component documents for the single admission application for which the applicant is registered. If a determination is made at 604 that the applicant is registered for more than one admission application, then 608 follows 604. At 608, the server 106 reviews the status of the documents for all of the applicant's admission applications and generates a consolidated report (perhaps divided up college by college, perhaps divided in another way, such as by items outstanding and not outstanding) of the admission application component documents. Then at 610 the server 106 presents (e.g., downloads) the consolidated report to the applicant's computer.

Referring once more to FIG. 3A, after step 314 the server 106 determines at 316 whether any of the applicant's admission application component documents have the status “misdirected”. If so, the applicant may take corrective measures 318, such as printing out a new label (with a fresh PLANET code) and a new letter of recommendation form, and asking the letter-writer in question to re-submit the letter of recommendation. The applicant could also request that the server 106 notify the delivery service that the item has been misdirected. The delivery service may then take corrective action to ensure the document is properly delivered. Of course other appropriate corrective action may be taken if the misdirected item is not a letter of recommendation.

At 320 in FIG. 3A, the server 106 may determine whether a deadline is approaching with respect to one or more admission applications or for submission of some of the component documents of an application. If such is the case, the server may then determine (at 322, FIG. 3B) whether any items for the application remain outstanding (i.e., having the status of “not yet mailed”). If so, step 324 follows. At step 324, the server 106 may directly send reminders, by e-mail and/or otherwise (e.g., by instant message, facsimile, physical mail, text message, and/or telephone call), to the parties (including the applicant) who have yet to submit the required documents. In addition or alternatively the server 106 may prompt the applicant to send reminders. In some embodiments, steps 320-324 may be performed by the server 106 independently of whether or when the applicant logs on to the website maintained by the server 106.

In some embodiments, the high school guidance departments may also have computers (not shown) that access the server computer 106; for example, the guidance departments may get duplicates of the reports sent to applicants by the server computer, or may have a back-up PIN for each student at the respective school to allow the school to access the student's account in case the student loses his/her computer capabilities (e.g., by misplacing his/her computer). Also, a college may associate a group of IDs with a set of documents for a single application and then provide them to a user with a PIN. Then, the user could access them online without ever providing information about themselves.

The invention has heretofore been described mainly in the context of a system for tracking documents that make up a college admission application. However, the principles of the present invention are also applicable to tracking assembly of other groups of documents, such as those required for insurance claim files, legal case files or hospital admission medical record files. The tracking of the documents may be by techniques other than detection of PLANET codes and/or POSTNET codes. For example, other types of barcodes or optically readable symbols (including human-readable characters) may be used to track the documents, and/or RFID tagging may be employed. The entity delivering the documents need not be a postal authority but rather may be a private carrier, such as Fedex, UPS, etc. The documents may be delivered in electronic form (e-mail and/or facsimile).

In the case of college admission applications (or in other cases) the recipient organization may continue to use PLANET codes and/or other tracking mechanisms to track the progress of the document through the recipient organization. As used herein, the object of the workflow processing is a college application for a college applicant, but as can be appreciated in alternatives, the applicant could instead apply to an object of the workflow creation such as the assembly of a medical record for a patient whereby the object of that process, the patient, is the applicant. Furthermore, there may be an agent actor on behalf of the applicant such as a parent or guidance department acting on the applicant's behalf and each such agent may have separate authority levels to enable certain levels of tasks to be completed.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
assigning a respective document tracking identifier to each of a plurality of documents, said documents being required for a college admission application;
allowing a user to register, with a central computer, as an applicant for college admissions in connection with said college admission application;
associating said document tracking identifiers with said user;
detecting handling or absence of handling of said documents by a document delivery service; and
reporting to said user, via said central computer, at least some data obtained from said detecting step.

2. The method according to claim 1, further comprising:
detecting whether one of said documents has failed to be handled by said document delivery service by a pre-determined time; and
notifying the user that said document has failed to be handled by said document delivery service.

3. The method according to claim 1, wherein the document delivery service is the U.S. Postal Service.

4. The method according to claim 3, wherein the document tracking identifiers are evidenced as PLANET codes on the documents.

5. The method according to claim 4, wherein the detecting step includes scanning PLANET codes on envelopes carried by the U.S. Postal Service.

6. The method according to claim 1, further comprising:
sending a reminder from the central computer to a third party whom the user requested to submit one of said documents.

7. The method according to claim 1, wherein said assigning step includes associating, in said central computer, said document tracking identifiers with the college admission application of said user.

8. The method according to claim 1, wherein said assigning step includes a college admissions office applying said document tracking identifiers on envelopes and sending said envelopes to said user.

9. The method according to claim 1, wherein said assigning step includes the user downloading the document tracking identifiers from said central computer, the user printing out said document tracking identifiers on labels, and the user applying said labels to said documents.

10. The method according to claim 1, wherein the reporting step includes reporting to the user when each of the plurality of documents is delivered to a college admissions office.

11. A method comprising:
associating a plurality of documents with a completion task; and
tracking whether and to what extent each of said documents progresses through a document delivery system to a destination.

12. The method according to claim 11, wherein:
the completion task is completion of a college admission application; and
the destination is a college admissions office.

13. The method according to claim 12, wherein:
the document delivery system is the U.S. Postal Service; and
the tracking step includes receiving information from the U.S. Postal Service.

14. The method according to claim 13, wherein the tracking step includes reading PLANET codes on the documents.

15. The method according to claim 11, wherein the completion task is completion of an insurance claim file.

16. The method according to claim 11, wherein the completion task is completion of a record of a medical record.

17. A computer system, comprising:
a database that includes a plurality of applicant records, each record for associating a plurality of document tracking identifiers with a respective applicant;
receiving means for receiving data from a document delivery service, said data indicative of locations at which said document tracking identifiers are detected by said document delivery service;
means, responsive to said means for receiving, for accessing said database and reporting, to said applicants, progress of documents through said document delivery service.

18. The computer system according to claim 17, further comprising:
means for determining and reporting, to the applicants, impending deadlines relevant to document tracking identifiers that have not been detected.

19. The computer system according to claim 18, further comprising:
means for sending reminders to parties appointed to send documents, said sending of reminders in response to the receiving means not receiving reports of respective document tracking identifiers.

20. The system according to claim 19, further comprising:
means for receiving data from applicants to associate the applicants with respective sets of the document tracking identifiers.
